(19) United States
(12) Patent Application Publication
(10) Pub. No.: US 2023/0238669 A1
(43) Pub. Date: Jul. 27, 2023

(54) SECONDARY BATTERY

(71) Applicant: SAMSUNG SDI CO., LTD., Yongin-si (KR)

(72) Inventor: Ho Geun LEE, Yongin-si (KR)

(21) Appl. No.: 18/102,182

(22) Filed: Jan. 27, 2023

(30) Foreign Application Priority Data
Jan. 27, 2022 (KR) 10-2022-0012602

(51) Int. Cl. H01M 50/566; H01M 50/105; H01M 50/178; H01M 50/574

(52) U.S. Cl. CPC H01M 50/566; H01M 50/105; H01M 50/178; H01M 50/574

(57) ABSTRACT

A secondary battery includes a case that accommodates an electrode assembly including a plurality of first electrode plates coated with a first active material, a plurality of second electrode plates coated with a second active material, and a separator positioned between each of the first electrode plates and each of the second electrode plates; lead tabs connected to the first electrode plates and the second electrode plates, respectively, and protruding outside of the case; and a protection circuit board electrically connected to the lead tabs, wherein the protection circuit board includes a pad including a blank region and a cell seating region, the lead tabs are seated on the cell seating region, and the blank region is along an edge of the cell seating region.

### CROSS-REFERENCE TO RELATED APPLICATION

This application claims priority to and the benefit of Korean Patent Application No. 10-2022-0012602 filed on Jan. 27, 2022, in the Korean Intellectual Property Office, the contents of which in its entirety are herein incorporated by reference.

### BACKGROUND

### 1. Field

Embodiments relate to a secondary battery.

### 2. Description of the Related Art

In general, unlike a primary battery that cannot be charged, a secondary battery can be charged and discharged. A secondary battery may be used in the form of a single battery or in the form of a battery module in which multiple batteries are connected and bundled into a single unit, depending on the type of external device applied.

As secondary batteries are used in large vehicles such as hybrid vehicles beyond being used as power sources of small electronic devices such as mobile phones and notebook computers, demand for high-output and high-capacity batteries is rapidly increasing.

The above information disclosed in this Background section is only for enhancement of understanding of the background and therefore it may contain information that does not constitute prior art.

### SUMMARY

The embodiments may be realized by providing a secondary battery including a case that accommodates an electrode assembly including a plurality of first electrode plates coated with a first active material, a plurality of second electrode plates coated with a second active material, and a separator positioned between each of the first electrode plates and each of the second electrode plates; lead tabs connected to the first electrode plates and the second electrode plates, respectively, and protruding outside of the case; and a protection circuit board electrically connected to the lead tabs, wherein the protection circuit board includes a pad including a blank region and a cell seating region, the lead tabs are seated on the cell seating region, and the blank region is along an edge of the cell seating region.

The blank region may be a removed portion of the pad along the edge of the cell seating region.

The lead tabs may be laser welded to the cell seating region.

The cell seating region may have a width of 2.3 mm to 2.5 mm.

The cell seating region may have a height of 1.8 mm to 2.0 mm.

The blank region may have a width of 0.2 mm to 0.4 mm.

The secondary battery may further include an insulating layer in the blank region.

### BRIEF DESCRIPTION OF DRAWINGS

Features will be apparent to those of skill in the art by describing in detail exemplary embodiments with reference to the attached drawings in which:

FIG. 1A is a perspective view illustrating a secondary battery according to an embodiment of the present disclosure.

FIG. 1B is an exploded perspective view illustrating a process of coupling a battery cell and a protection circuit board in a secondary battery according to an embodiment of the present disclosure.

FIG. 2 is a plan view illustrating a protection circuit board of a secondary battery according to an embodiment of the present disclosure.

FIG. 3 is an enlarged view of portion A of FIG. 2.

FIG. 4 is an enlarged view of a conductive pattern of the protection circuit board in FIG. 3.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

As used herein, the terms “or” and “and/or” are not exclusive terms, and include any and all combinations of one or more of the associated listed items. In addition, it will be understood that when an element A is referred to as being “connected to” an element B, the element A can be directly connected to the element B or an intervening element C may be present therebetween such that the element A and the element B are indirectly connected to each other.

The terminology used herein is for the purpose of describing particular embodiments only and is not intended to be limiting of the disclosure. As used herein, the singular forms are intended to include the plural forms as well, unless the context clearly indicates otherwise. It will be further understood that the terms that the terms “comprise”, “include”, “comprising” or “including,” when used in this specification, specify the presence of stated features, numbers, steps, operations, elements, and/or components, but do not preclude the presence or addition of one or more other features, numbers, steps, operations, elements, components, and/or groups thereof.

It will be understood that, although the terms first, second, etc. may be used herein to describe various members, elements, regions, layers and/or sections, these members, elements, regions, layers and/or sections should not be limited by these terms, e.g., these terms are not intended to imply or require sequential inclusion. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings herein.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the element or feature in the figures is turned over, elements described as “below” or “beneath” other elements or features would then be oriented “on” or “above” the other elements or features. Thus, the exemplary term “below” can encompass both an orientation of above and below.

Hereinafter, prior to describing an electrode assembly according to an embodiment of the present disclosure with reference to the accompanying drawings, a general electrode assembly structure will be first described.

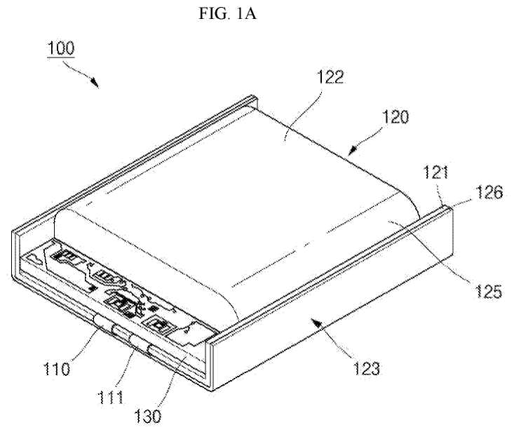

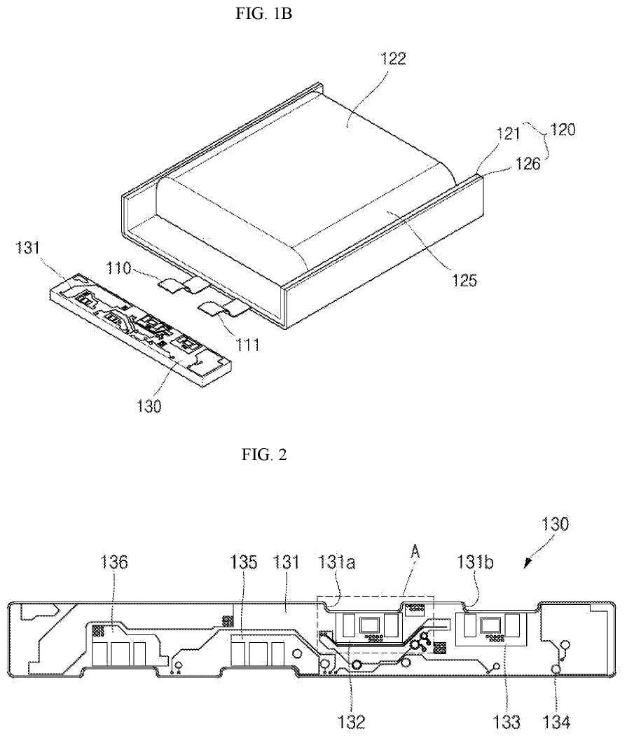

FIG. 1A is a perspective view illustrating a secondary battery according to an embodiment of the present disclosure. FIG. 1B is an exploded perspective view illustrating a process of coupling a battery cell and a protection circuit board in a secondary battery according to an embodiment of the present disclosure.

Referring first to FIG. 1A, the secondary battery 100 according to the present disclosure may include lead tabs 110 and 111 extending from an electrode assembly, a case 120 containing an electrode assembly, and a protection circuit board 130.

In an implementation, a built-in electrode assembly may have a structure in which a first electrode plate formed by applying a first active material to both surfaces of a substrate, a separator, and a second electrode plate formed by applying a second active material to both surfaces of a substrate, are sequentially stacked. In an implementation, the separator may be inserted between the first electrode plate and the second electrode plate to help prevent a short circuit from occurring between the electrode plates. In an implementation, the first electrode plate may include a positive electrode plate and the second electrode plate may include a negative electrode plate, but polarities can also be interchanged.

In an implementation, a first lead tab 110 and a second lead tab 111 may be coupled to ends of the first electrode plate and the second electrode plate, respectively, to be electrically connected to external electrode terminals. In an implementation, an insulating tape may be included on a portion where each of the first lead tab 110 and the second lead tab 111 is coupled to the case 120.

The case 120 may be in the form of a pouch as shown, or may be a can-type case used for a prismatic battery or the like. Hereinafter, for convenience, the case 120 will be described as a pouch type.

The case 120 may include, with respect to a bent region, a first region in which the electrode assembly is accommodated through an inner groove, and a second region that is folded around a boundary in contact with the first region to seal the first region.

In an implementation, the groove in the first region may have a depth substantially corresponding to a thickness of the electrode assembly. In an implementation, when the electrode assembly is accommodated in the first region, the first lead tab 110 and the second lead tab 111 may be exposed through the boundary of the first region.

In an implementation, in this state, the second region may be folded so that the second region seals the first region, and only the first lead tab 110 and the second lead tab 111 may extend and be exposed through a region between the first region and the second region.

Referring to FIG. 1B together with FIG. 1A, the protection circuit board 130 may be electrically connected to the exposed first and second lead tabs 110 and 111. Electrical patterns for such an electrical connection may be on the surface of the protection circuit board 130 and may be coupled to the first lead tab 110 and the second lead tab 111 through, e.g., laser welding, respectively. If excessive laser output were to be generated or applied during this welding process, damage could occur to the protection circuit board 130, and short circuits between patterns could occur. In an implementation, such short circuits may be prevented by varying patterns as will be described below.

In an implementation, after being welded to the first lead tab 110 and the second lead tab 111 in such a state as shown in FIG. 1B, the protection circuit board 130 may be folded upwardly by about 90 degrees and positioned at the front end of the case 120 as shown in FIG. 1A. Circuit components, such as a positive temperature element (PTC), may be separately further coupled to a top portion of the protection circuit board 130, and terminals to facilitate charging and discharging the battery cell with the outside may be further coupled.

Hereinafter, a configuration of a protection circuit board used in a secondary battery according to an embodiment of the present disclosure will be described in detail.

FIG. 2 is a plan view illustrating a protection circuit board used in a secondary battery according to an embodiment of the present disclosure.

Referring to FIG. 2, the protection circuit board 130 used in the secondary battery according to the embodiment of the present disclosure may include a substrate body 131, and a first conductive pattern 132 (e.g., pad) and a second conductive pattern 133 on the substrate body 131. The first lead tab 110 and the second lead tab 111 may be welded to the protection circuit board 130 at the first conductive pattern 132 and the second conductive pattern 133, respectively. In an implementation, the conductive patterns 132 and 133 of the substrate body 131 may be connected to a desired path inside the protection circuit board 130 through a wiring 134. In an implementation, grooves 131a and 131b (e.g., formed by removing portions of a side of the substrate body 131) may be included in regions in or at which the lead tabs 110 and 111 of the battery cell are coupled to the first conductive pattern 132 and the second conductive pattern 133. When the lead tabs 110 and 111 are later welded to the first conductive pattern 132 and the second conductive pattern 133, respectively, or when the lead tabs 110 and 111 are later folded, such grooves 131a and 131b may facilitate smooth performance of the operations.

In an implementation, a third conductive pattern 135 and a fourth conductive pattern 136 may be on or at the other side of the substrate body 131. In an implementation, the third conductive pattern 135 and the fourth conductive pattern 136 may be symmetrical with the first conductive pattern 132 and the second conductive pattern 133. In an implementation, the third conductive pattern 135 and the fourth conductive pattern 136 may be configured such that a lead tab of a second battery cell may be connected when a plurality of battery cells are coupled, or a PTC device, or the like may be used for the coupling purpose. In an implementation, the second conductive pattern 133 to the fourth conductive pattern 136 may have the same configuration as the first conductive pattern 132, and the first conductive pattern 132 will be mainly described below.

Hereinafter, the structure of the first conductive pattern 132 will be described in detail.

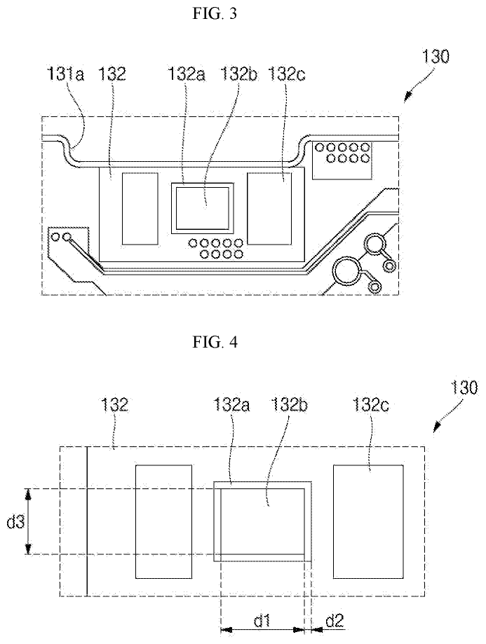

FIG. 3 is an enlarged view of portion A of FIG. 2.

As shown in FIG. 3, the first conductive pattern 132 may include a cell seating region 132b inside a blank region 132a formed by emptying or removing a portion of the first conductive pattern 132 (e.g., by removing a portion of the protection circuit board 130 around the cell seating region 132b in a depthwise direction to form a groove-like blank region 132a). The first lead tab 110 or the second lead tab 111 may be later seated in or on the cell seating region 132b, and laser welding may be later performed. In an implementation, the blank region 132a may be formed by removing a pattern or other material along or around the edge of the cell seating region 132b. In an implementation, in the first conductive pattern 132, the blank region 132a may electrically and physically separate or isolate the cell seating region 132b from other regions of the first conductive pattern 132. In an implementation, an insulating layer or other material, e.g., an insulating tape, may be provided on the upper surface of or in the blank region 132a (e.g., filling in a space or groove formed by removing the portion of the protection circuit board 130 when forming the blank region 132), which may be helpful for enhancing electrical independence or isolation of the blank region 132a.

Due to the presence of this blank region 132a, even if the output of the laser used in the laser welding of the lead tabs 110 and 111 were to be excessively high, a short circuit with other regions of the adjacent first conductive pattern 132 may be prevented. In an implementation, a wiring, separate from other regions of the first conductive pattern 132, may be connected to the cell seating region 132b to form an electric path within the protection circuit board 130. Such wiring may be connected through a via formed in the vertical direction of the protection circuit board 130 formed in a multilayer structure, the blank region 132a and the wiring may be on different layers within the substrate body 131, and thus may not interfere with each other.

In an implementation, a peripheral pattern region 132c (in or on which other devices such as other PTCs may be included) may be outside (e.g., adjacent to) the blank region 132a. In an implementation, through the blank region 132a, the peripheral pattern region 132c may be electrically and physically independent of or isolated from the cell seating region 132b.

Hereinafter, detailed numerical values of elements of the first conductive pattern 132 will be described in detail.

FIG. 4 is an enlarged view of a first conductive pattern of the protection circuit board in FIG. 3.

Referring to FIG. 4, in the first conductive pattern 132, the width d1 and height d3 of the cell seating region 132b and the width d2 of the blank region 132a are shown.

In an implementation, the cell seating region 132b may have a width d1 of 2.3 mm to 2.5 mm. The magnitude of the width dl of the cell seating region 132b may be set to be equal to or a slight margin greater than the width magnitude of the lead tab 110, 111, and welding may be easily performed in a state in which the lead tabs 110 and 111 are seated.

In an implementation, the cell seating region 132b may have a height d3 of 1.8 mm to 2.0 mm. The height d3 may facilitate performing laser welding. Maintaining the height d3 at 1.8 mm or more may help ensure that a worker can easily perform welding and the bonding force according to welding may be maintained. Maintaining the height d3 at 2.0 mm or less may help ensure that a wiring pattern may be advantageously set within a limited area of the protection circuit board 130.

In an implementation, the blank region 132a may have a width d2 of 0.2 mm to 0.4 mm. The blank region 132a may be at or surround the edge of the cell seating region 132b with the same, e.g., uniform, width d2. Maintaining the width d2 of the blank region 132a at 0.2 mm or more may help ensure that electrical isolation of the cell seating region 132b may be stably achieved. Maintaining the width d2 of the blank region 132a at 0.4 mm or less may help ensure that the area of the cell seating region 132b may be secured within the first conductive pattern 132.

In an implementation, in the secondary battery according to an embodiment of the present disclosure, by forming the blank region 132a (e.g., by emptying or removing a pattern on or around the edge of the cell seating region 132b) where the lead tabs 110 and 111 of the battery cell are welded to the protection circuit board 130, it is possible to help prevent a short circuit from occurring with other regions outside the cell seating region 132b even if the laser output were to be excessive.

By way of summation and review, in a secondary battery, in order to control charging and discharging operations, a protection circuit board may be coupled to a battery cell, and the battery cell and the protection circuit board may be bonded through welding.

One or more embodiments may provide a structure which helps prevent occurrence of pattern short circuit during laser welding of a protection circuit board.

As described above, in the secondary battery according to an embodiment of the present disclosure, by forming a blank region formed by blanking a pattern on the edge of the cell seating region where the lead tab of the battery cell is welded to a protection circuit board, it is possible to help prevent a short circuit with other regions outside the cell seating region even when the laser output is excessive.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
a case that accommodates an electrode assembly including a plurality of first electrode plates coated with a first active material, a plurality of second electrode plates coated with a second active material, and a separator positioned between each of the first electrode plates and each of the second electrode plates;
lead tabs connected to the first electrode plates and the second electrode plates, respectively, and protruding outside of the case; and
a protection circuit board electrically connected to the lead tabs,
wherein:
the protection circuit board includes a pad including a blank region and a cell seating region,
the lead tabs are seated on the cell seating region, and
the blank region is along an edge of the cell seating region.

2. The secondary battery as claimed in claim 1, wherein the blank region is a removed portion of the pad along the edge of the cell seating region.

3. The secondary battery as claimed in claim 1, wherein the lead tabs are laser welded to the cell seating region.

4. The secondary battery as claimed in claim 1, wherein the cell seating region has a width of 2.3 mm to 2.5 mm.

5. The secondary battery as claimed in claim 1, wherein the cell seating region has a height of 1.8 mm to 2.0 mm.

6. The secondary battery as claimed in claim 1, wherein the blank region has a width of 0.2 mm to 0.4 mm.

7. The secondary battery as claimed in claim 1, further comprising an insulating layer in the blank region.
